(19) United States
(12) Patent Application Publication
(10) Pub. No.: US 2003/0050889 A1
(43) Pub. Date: Mar. 13, 2003

(54) Creation and distribution of deposits and payments to financial institutions

(76) Inventor: Bertram V. Burke, Red Bank, NJ (US)

Correspondence Address: Leo Stanger, 382 Springfield Ave., P.O. Box 1455, Summit, NJ, 07901, US

(21) Appl. No.: 09/950,566

(22) Filed: Sep. 11, 2001

(51) Int. Cl. G06F 17/60

(52) U.S. Cl. 705/40

(57) ABSTRACT

At non-bank and financial institution locations, account holders use remote inputs to send deposits and payments in cash and/or checks to their accounts in financial institutions. In one embodiment the remote input used at merchant point of sale locations truncates paper checks and cash at the remote terminal level.

### FIELD OF THE INVENTION

This invention relates to the creation and distribution of deposits and payments from account holders to financial institutions, and particularly to checking, savings, investment, and credit accounts.

### BACKGROUND OF THE INVENTION

In the current situation an account holder can make deposits or payments to their accounts held by a financial institution using mail, a bank teller, an ATM, their employer making a direct payroll deposit, or by account transfer from another financial institutions.

An object of the invention is to improve such methods and systems.

### SUMMARY OF THE EMBODIMENTS

An embodiment of the invention involves the account holder using a remote input to make a deposit or payment to a financial institution. Said remote input (1) records and forwards account information on account holders who are making deposits and payments, (2) records and forwards information and funds from the business or personal accounts used by forwarding agents to transfer cash to the designated financial institutions, (3) has the internal or connected capability of accepting, storing, and counting, bills and coins designated for deposit, (4) records and forwards information to financial networks corresponding to the amount of cash and checks being deposited, (5) has scanning and imaging capability to create and forward digital images of both sides of paper checks used for deposit or payment to networks operated by financial institutions, (6) accepts acknowledgement back from the financial networks that the information forwarded, has been properly stored, and (7) based upon instructions from the financial networks, the remote input will then stamp cancel or shred the physical checks used in the payment or deposit. Said remote unit will also have a communication system within the remote input unit to bi-directionally communicate with networks operated by financial institutions.

In another embodiment, the invention involves the account holder using a remote input to make check and cash deposits and payments to a financial institution. In making deposits or payments, said remote input performs the following functions (1) records and forwards account information on account holders who are making deposits and payments, (2) has the internal or connected capability of accepting, storing, and counting, bills and coins designated for deposit, (3) records and forwards information to financial networks corresponding to the amount of cash and checks being deposited, (4) has scanning and imaging capability to create and forward digital images of both sides of paper checks used for deposit or payment to networks operated by financial institutions, (5) accepts acknowledgement back from the financial networks to the remote input that the information forwarded, has been properly stored, and (6) based upon instructions from the financial networks, the remote input will then stamp cancel or shred the physical checks used in the payment or deposit. Said remote unit will also have a communication system within the remote input unit to bi-directionally communicate with networks operated by financial institutions.

The various features of novelty that characterize the invention are pointed out in the claims. Other objects and advantages of the invention will become evident from the following detailed description when read in light of the following drawings.

### BRIEF DESCRIPTION OF THE DRAWINGS

FIG. 1 is a block diagram of the depositing system embodying features of the invention.

FIG. 2 is a block design of the parties involved in the depositing methodology shown in FIG. 1.

FIG. 3 is a flow of the data processing methodology for making deposits or payments to a financial institution that occurs in FIG. 1.

FIG. 4 is a block diagram of the depositing system embodying features of the invention.

FIG. 5 is a block design of the parties involved in the depositing methodology shown in FIG. 4.

FIG. 6 is a flow of the data processing methodology for making deposits or payments to financial institution that occurs in FIG. 4.

### DETAILED DESCRIPTION OF PREFERRED EMBODIMENTS

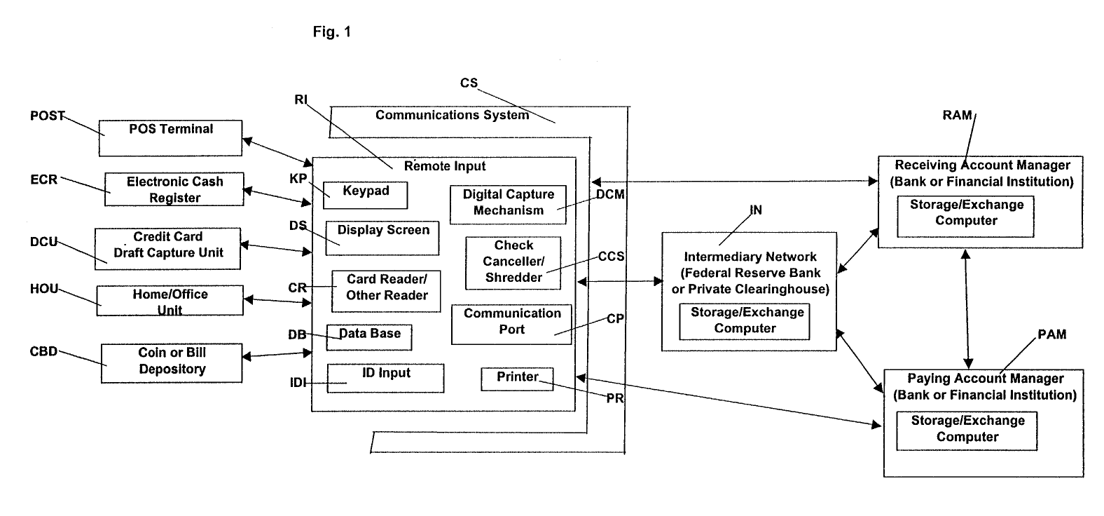

The block design in FIG. 1, shows the hardware in a network, which an account holder may make deposits or payments of cash and/or checks to an account managed by a financial institution.

The system uses a remote input RI that may be operated alone or the RI may be attached to an additional unit AU such as a point of sale terminal POST, electronic cash register ECR, credit card draft capture unit DCU, a home/office personal or business computer unit HOC, and/or a coin/bill depository CBD.

As indicated in the block design in FIG. 1, one of the embodiments of the system would have the remote input RI equipped with a keypad KP, a card reader CR (that may read a bar code, magnetic stripe, or a chip card), and any other inputs OI, (i.e. such as wireless input device WID, a voice activated input VAI), a display screen DS, a digital capture mechanism DCM, a check canceller/shredder CC/S, a printer PR, a coin/bill depository CBD, a communication port CP, and a data base DB.

Connecting the remote input RI and any additional unit AU to financial networks will be a communication system CS that may include telephone lines, wireless telephone connections, satellites, or cable connections.

The functions provided by the remote input RI will include, but will not be limited to, (1) recording and forwarding account information on account holders who are making deposits and payments, (2) recording and forwarding account information on the business or personal accounts used by agents to facilitate the transfer of cash provided by account holders AH for deposit or payment, (3) accepting, storing, and counting of bills and coins for deposit, (4) recording and forwarding information corresponding to the amount of cash and/or checks being deposited, (5) performing scanning and imaging services to create and forward digital images of both sides of paper checks, (6) after forwarding digitized information on the checks to financial networks, recording and storing acknowledgements back from the bank networks that the critical information has been properly stored, and (7) carrying out the instructions from the bank networks to stamp cancel or shred the physical checks used in the payment or deposit transaction.

Throughout this specification, the term x, when appended to the end of a reference character, is equal to 1, . . . M, . . . N.

In other embodiments of the invention, the RI and other computers in FIG. 1, could be operated in other configurations or designs.

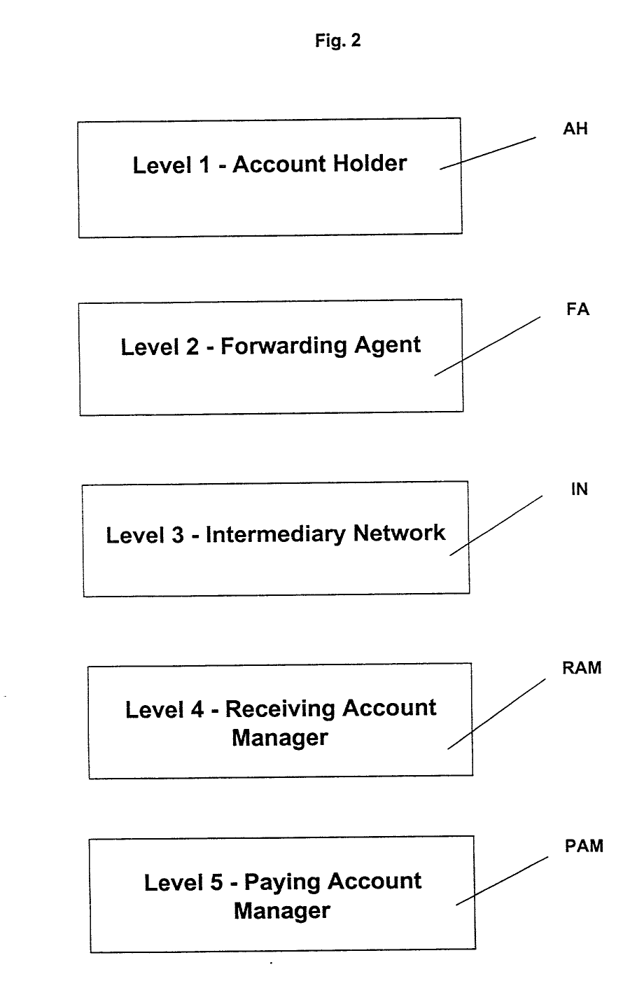

In FIG. 2, shows an embodiment of the invention that includes a five level system.

The first level involves an Account Holder AH, who may be any type of financial transactor such as a person, institution, governmental entity, trust, corporation, or a customer, and who may hold one or more accounts of any kind such as a checking, credit, debit, home equity, or smart card accounts. It is the goal of the Account Holder AH to use the invention to make a payment or deposit to a financial institution that holds their account.

The second level involves Forwarding Agents FA who operate the remote input RI units used to collect, process, and forward deposits or payments (in the form of cash and/or check) to the financial institutions selected by the Account Holders.

Said Forwarding Agent FA may be third party entities such as supermarkets owners, retail merchants, governmental agencies, i.e. U.S. Post Office, owners of stand alone commercial coin/bill counting machines, etc.

According to an embodiment of the invention when a cardholder tenders cash in the form of coins and/or bills to a third party agent, the third party accepts the cash and makes deposits to their business or personal account. Under such an arrangement, the Agent's bank will then ACH transfer the cash deposits to the financial institution that the Account Holder AH selected for the deposit or payment.

Commonly, the third party entity that accepts the Account Holder's AH cash will have previously entered into a trust relationship with the financial institutions that will eventually receive the funds. This type of fiduciary arrangement is presently in place when merchants act as agents for financial institutions that provide money transmitters services (money orders and money grams) for consumers at point of sale locations.

According to another embodiment, when checks are provided by the Account Holders AH for deposit or payment the following will take place:

(1) Agents will enter each check, one at time, into a scanner or reader so that both sides of the check are digitized. Each individual check will stay in the remote unit until it receives final instructions from one of the financial networks.

(2) Once an individual check is digitized, the remote input RI unit will forward the images to the financial networks for storage and acknowledgement.

(3) Once the images are successfully secured in the financial network, the receiving and storing computer will send an acknowledgement back to the remote input RI along with computer instructions (that could be mandatory) to stamp cancel or shred the check that is being held inside the RI.

(4) The RI will then stamp cancel or shred the check and if available similarly process the next check.

(5) After the RI processes all checks and/or cash, the RI will provide a receipt showing the details behind the transaction.

When operators of coin and/or bill accepting machines act as Forwarding Agents FA, they will follow the same procedures and assume the same responsibilities as other point of sale merchants.

As an alternative embodiment to the third party Forwarding Agent FA operating the RI, may be the Account Holder him or herself. The AH may perform the Agent's role by entering deposit or payment data into a personal or business computer, Internet appliance, a modified fax machine, etc. Under such an arrangement the deposits or payments will only be in the form of checks.

The third level involves an Intermediary Network IN that would be the Federal Reserve Bank or a privately operated bank clearinghouse. The Intermediary Network IN receives the initial depositing and payment information acting as the first bank of deposit. Under such an arrangement, multiple remote input RIx units operating within level 2, will make deposits or payments to the Intermediary Network IN.

Once level 3 accepts and stores the information from the Forwarding Agent FA, level 3 will send an acknowledgement back to level 2 along with computer instructions to stamp cancel or shred a check being held within the RI unit

The fourth level is the Receiving Account Manager RAM, a financial institution that holds the checking, credit, debit, home equity, or smart card accounts of the Account Holder AH.

In order to allow the completion of the deposit or payment to level 4, level 3 will forward all the needed information required by level 4.

The fifth level is the Paying Account Manager PAM, a financial institution that makes payments when required to a Receiving Account Manager RAM.

In order to make funds transfer from level 5 to level 4, level 3 will also forward all the needed information required to level 5. Level 5 as the paying account manager will also make all final debits to the accounts that it manages.

According to another embodiment the remote input RI could skip sending its deposit or payment data to level 3 and report the data and complete the depositing or payment process directly with level 4 or 5. Under such circumstances, level 4 would send the data to 5 or level 5 would send the data to level 4 to complete the transaction process.

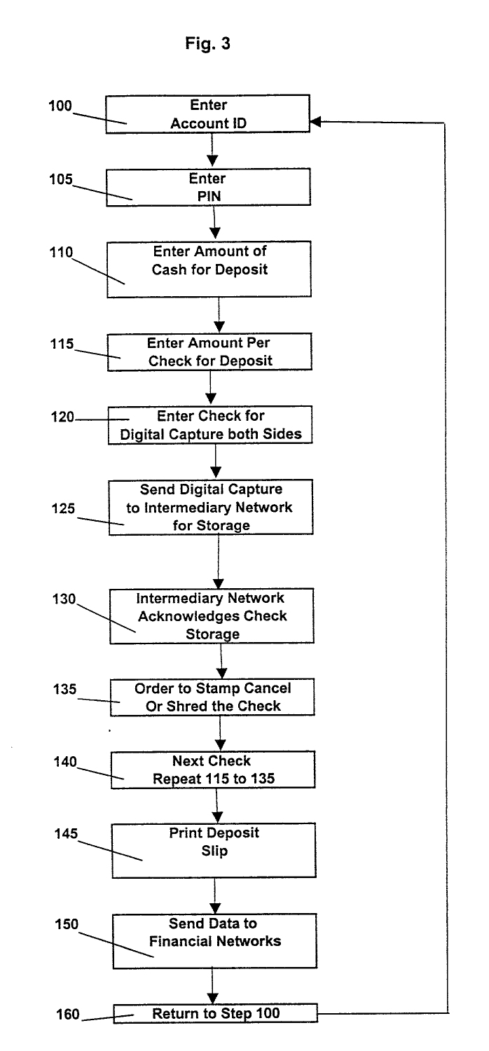

FIG. 3, is a flow chart which illustrates the steps in a computer which takes place in FIG. 1, when an Account Holder AH, makes a deposit or payment into a remote input RIx.

In step 100, software in the RI tells the Account Holder AH (or a clerk) to enter in their ID and account information by key stroking in an account number or using a magnetic stripe, bar coded, or chip card. At this point the software may also require a biometric scan such as an Iris scan, voice activated, or other entry means.

In step 105, the RI instructs the AH to enter their PIN or password using any of the above methods.

In step 110, the RI requests the AH to enter in the amount of cash being deposited, if any.

In step 115, the RI requests the AH to enter the face amount of a check being deposited.

In step 120, the RI instructs the AH to enter the check into the digital capture mechanism DCM. Once inserted into the DCM, the check is scanned on both sides. The digital image of the front of the check captures the amount of the check, the signature of the payor, the bank routing number of the issuing bank, the payee's name on the check, the date, and any added notes. The digital image of the back of the check shows the signatures of any endorsers.

In step 120 the check stays in the DCM for stamp canceling or shredding, if approved, at step 135.

In step 125, the scanned images are sent to an off site to a Intermediary Network IN at level 3 or to the Receiving Account Manager RAM at level 4 or to the Paying Account Manager PAM at level 5 using the remote input's RI's communication capabilities CS.

In step 130, the remote input RI receives an acknowledgment message from the IN, RAM, or PAM that both scanned images are safe and secure in a financial institution's computer network. Once secured in the financial network computers, the digitized check images will be available to verify signatures, show proof of deposit, show the paying bank, and provide a canceled check record for the checking account customer.

In step 135, once the remote input RI receives acknowledgement that the images are safely stored, the check still being held in the DCM at step 120 is stamped cancelled or shredded.

If additional checks are being deposited, in step 140, the RI instructs the AH to repeat steps 115 through 135 for each check being deposited.

In step 145, the remote input RI prints a deposit slip that shows the amount of cash deposited in the RI, the check(s) being deposited, the identification of the depositor, the time and date, the amount in all checks, reference numbers of the stored check images, the bank routing number on the payor's check, and the ID of the RIx.

In step 150, the RI sends a digitized information packet that contains the details in step 145 plus the merchant's checking account information MCA to the Intermediary Network IN, Receiving Account Manager RAM, and/or the Paying Account Manager PAM. In step 150, the order of communications to the various parties can vary based upon the individual needs of any one financial institution.

At step 160, the RI returns to step 100.

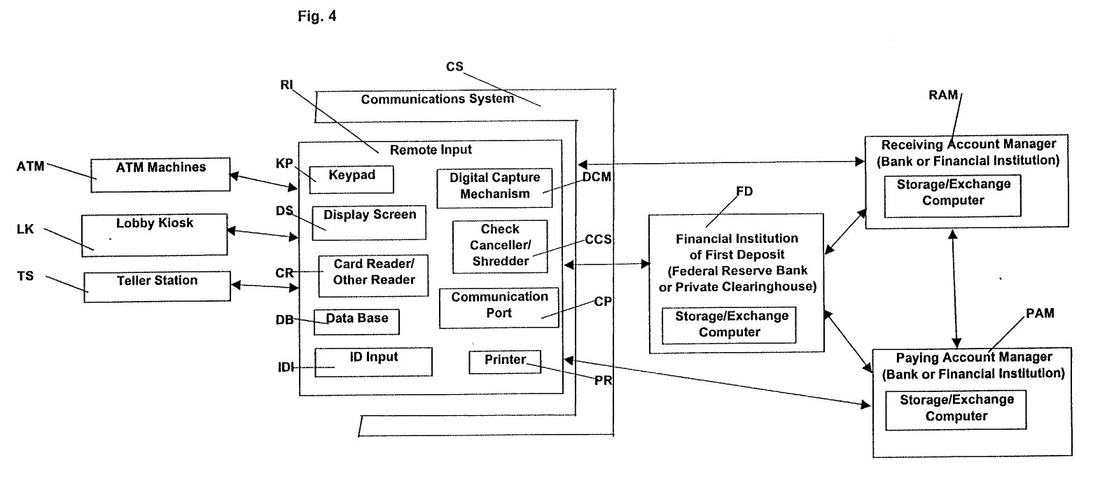

The block design in FIG. 4, shows the hardware in a network, which an account holder may make deposits or payments of cash and/or checks to an account managed by a financial institution.

The system uses a remote input RI that may be operated alone or the RI may be attached to an additional unit AU such as an ATM machine, a lobby kiosk, or a PC or other computer operated by a teller or financial services representative.

As indicated in the block design in FIG. 1, one of the embodiments of the system would have the remote input RI equipped with a keypad KP, a card reader CR (that may read a bar code, magnetic stripe, or a chip card), and any other inputs 01, (i.e. such as wireless input device WID, a voice activated input VAI), a display screen DS, a digital capture mechanism DCM, a check canceller/shredder CC/S, a printer PR, a coin/bill depository CBD, a communication port CP, and a data base DB.

Connecting the remote input RI and any additional unit AU to financial networks will be a communication system CS that may include telephone lines, wireless telephone connections, satellites, or cable connections.

The functions provided by the remote input RI will include, but will not be limited to, (1) recording and forwarding account information on account holders who are making deposits and payments, (2) accepting, storing, and counting of bills and coins for deposit, (4) recording and forwarding information corresponding to the amount of cash and/or checks being deposited, (5) performing scanning and imaging services to create and forward digital images of both sides of paper checks, (6) after forwarding digitized information on the checks to financial networks, recording and storing acknowledgements back from the financial networks that the critical information has been properly stored, and (7) carrying out the instructions from the bank networks to stamp cancel or shred the physical checks used in the payment or deposit transaction.

Throughout this specification, the term x, when appended to the end of a reference character, is equal to 1, . . . M, . . . N.

In other embodiments of the invention, the RI and other computers in FIG. 1, could be operated in other configurations or designs.

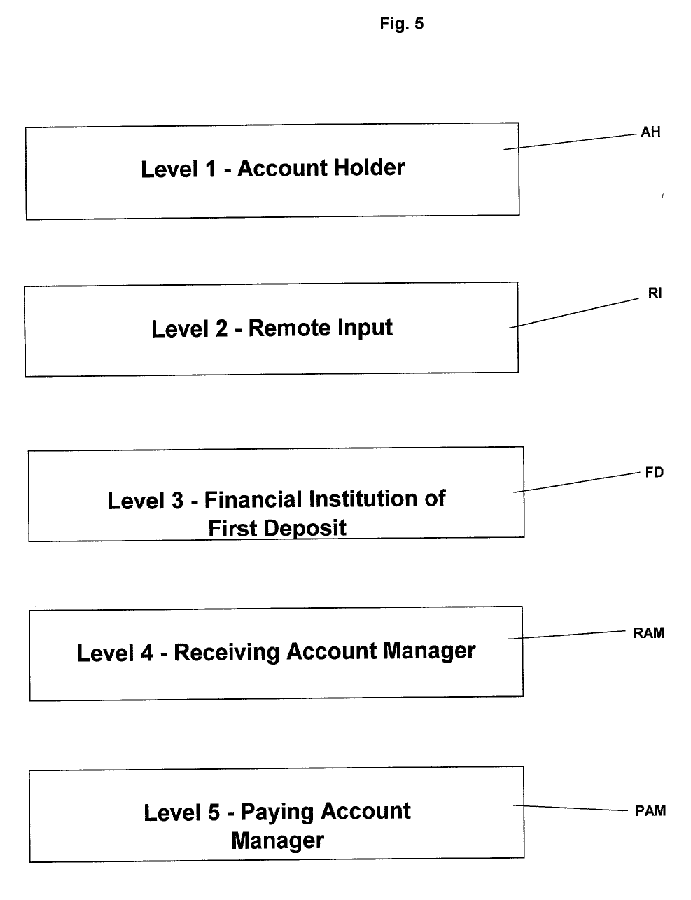

In FIG. 5, shows an embodiment of the invention that includes a five level system.

The first level involves an Account Holder AH, who may be any type of financial transactor such as a person, institution, governmental entity, trust, corporation, or a customer, and who may hold one or more accounts of any kind such as a checking, credit, debit, home equity, or smart card accounts. It is the goal of the Account Holder AH to use the invention to make a payment or deposit to a financial institution that holds their account.

The second level involves the Remote Input RI units used to collect, process, and forward deposits or payments (in the form of cash and/or check) to the financial institutions selected by the Account Holders.

Said Remote Inputs RI are controlled by the financial networks that receive the deposits. They may be operated by employees of the financial networks or by Account Holders AH themselves. The Remote Input units may be located in the lobbies of the financial institutions, ATM machines, teller stations, and stand alone kiosks located in banks, supermarkets, retail merchant locations, governmental agencies, i.e. U.S. Post Office, etc.

According to another embodiment, when checks are entered into a Remote Inputs for deposit or payment the following will take place:

(1) Account Holders AC or employees of the financial networks will enter each check, one at time, into a scanner or reader so that both sides of the check are digitized. Each individual check will stay in the remote unit until it receives final instructions from one of the financial networks.

(2) Once an individual check is digitized, the remote input RI unit will forward the images to the financial networks for storage and acknowledgement.

(3) Once the images are successfully secured in the financial network, the receiving and storing computer will send an acknowledgement back to the remote input RI along with computer instructions (that could be mandatory) to stamp cancel or shred the check that is being held inside the RI.

(4) The RI will then stamp cancel or shred the check and if available similarly process the next check.

(5) After the RI processes all checks and/or cash, the RI will provide a receipt showing the details behind the transaction.

The third level involves the Financial Institution of First Deposit FD that could be the Account Holder's AH bank that manages its account, the Federal Reserve Bank, or a privately operated bank clearinghouse. The Financial Institution of First Deposit FD receives the initial depositing and payment information acting as the first bank of deposit. Under such an arrangement, multiple remote input RIx units operating within level 2, will make deposits or payments to the Financial Institution of First Deposit FD.

Once level 3 accepts and stores the information from the Remote Inputs RI, level 3 will send an acknowledgement back to level 2 along with computer instructions to stamp cancel or shred a check being held within the RI unit

If level 3 is not the manager of the Account Holders AH account but instead it is a private or government owned clearinghouse, the fourth level is the Receiving Account Manager RAM, a financial institution that holds the checking, credit, debit, home equity, or smart card accounts of the Account Holder AH.

In order to allow the completion of the deposit or payment to level 4, level 3 will forward all the needed information required by level 4.

The fifth level is the Paying Account Manager PAM, a financial institution that makes payments when required to a Receiving Account Manager RAM.

In order to make funds transfer from level 5 to level 4, level 3 will also forward all the needed information required to level 5. Level 5 as the paying account manager will also make all final debits to the accounts that it manages.

According to another embodiment the remote input RI could skip sending its deposit or payment data to level 3 and report the data and complete the depositing or payment process directly with level 4 or 5. Under such circumstances, level 4 would send the data to 5 or level 5 would send the data to level 4 to complete the transaction process.

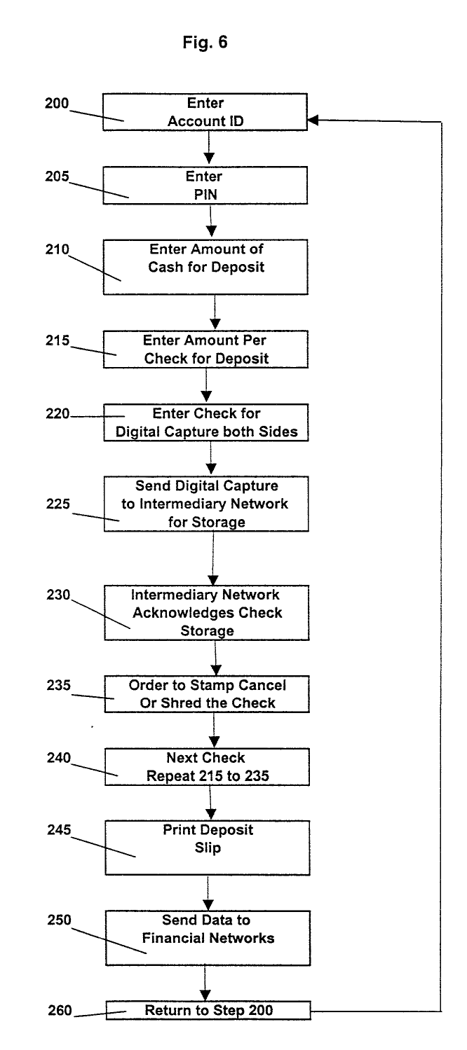

FIG. 6, is a flow chart which illustrates the steps in a computer which takes place in FIG. 1, when an Account Holder AH makes a deposit or payment into a remote input RIx.

In step 200, software in the RI tells the Account Holder AH (or a clerk) to enter in their ID and account information by key stroking in an account number or using a magnetic stripe, bar coded, or chip card. At this point the software may also require a biometric scan such as an Iris scan, voice activated, or other entry means.

In step 205, the RI instructs the AH to enter their PIN or password using any of the above methods.

In step 210, the RI requests the AH to enter in the amount of cash being deposited, if any.

In step 215, the RI requests the AH to enter the face amount of a check being deposited.

In step 220, the RI instructs the AH to enter the check into the digital capture mechanism DCM. Once inserted into the DCM, the check is scanned on both sides. The digital image of the front of the check captures the amount of the check, the signature of the payor, the bank routing number of the issuing bank, the payee's name on the check, the date, and any added notes. The digital image of the back of the check shows the signatures of any endorsers.

In step 220 the check stays in the DCM for stamp canceling or shredding, if approved, at step 235.

In step 225, the scanned images are sent to an off site to a Financial Institution of First Deposit FD at level 3 or to the Receiving Account Manager RAM at level 4 or to the Paying Account Manager PAM at level 5 using the remote input's RI's communication capabilities CS.

In step 230, the remote input RI receives an acknowledgment message from the Financial Institution of First Deposit FD, Receiving Account Manager RAM, or Paying Account Manager PAM that both scanned images are safe and secure in a financial institution's computer network. Once secured in the financial network computers, the digitized check images will be available to verify signatures, show proof of deposit, show the paying bank, and provide a canceled check record for the checking account customer.

In step 235, once the remote input RI receives acknowledgement that the images are safely stored, the check still being held in the DCM at step 120 is stamped cancelled or shredded.

If additional checks are being deposited, in step 240, the RI instructs the AH to repeat steps 215 through 235 for each check being deposited.

In step 245, the remote input RI prints a deposit slip that shows the amount of cash deposited in the RI, the check(s) being deposited, the identification of the depositor, the time and date, the amount in all checks, reference numbers of the stored check images, the bank routing number on the payor's check, and the ID of the RIx.

In step 250, the RI sends a digitized information packet that contains the details in step 245, to the Financial Institution of First Deposit FD, the Receiving Account Manager RAM, and/or the Paying Account Manager PAM. In step 250, the order of communications to the various parties can vary based upon the individual needs of any one financial institution.

At step 260, the RI returns to step 200.

The number one advantage for the banking industry is that the invention liberates relevant information on deposits or payments to financial institutions from the physical restraints imposed by the transfer of paper checks and coins and bills.

By truncating both checks and cash at the initial time of deposit financial institutions will realize multiple ways to save both time and money. The imaging of both sides of a check, and sending the images off to safe storage, removes the need for the billions of physical checks to be transported, handled, and processed through by the ACH or the banks. Once digitized there are numerous financial savings, as well as the fact that the clearing and posting process will be accomplished in a shorter time. The truncating of hard currency, used in deposits or payments, is possible because of ACH transfers from third party merchants.

In regard to Account Holders AH making deposits or payments using physical coins and bills at the point of sale or through a machine, this feature provide an additional break through resulting in the saving of additional time and money.

The invention's ability to extend and expand both merchant and home/office locations to include the capability of making deposits and payments, provides financial institutions with a wider scope and reach without requiring a major investment in capital spending. In fact the invention may enable financial institutions, such as banks, to close selected branch offices.

Consumers will also benefit because they will be able to go to supermarkets, convenience stores, etc. and simultaneously shop and bank, or make payments to other financial service providers while in a shopping location. This will save both time and money.

A special audience that will significantly benefit from the invention will be the Internet banking sector because now their customers can make deposits of cash and checks in millions of point of sale locations.

In addition customers will able to deposit checks to their accounts while never leaving their offices.

While embodiments of the invention have been described in detail, it will be evident to those skilled in the art that the invention may be embodied otherwise without departing from its spirit and scope. Therefore, the following claims are meant to encompass all alternatives and modifications within the scope and spirit of the present invention.

What is claimed is:

1. A system, comprising:
a remote input;
entry means in the remote input to image a check,
entry means in the remote input to record the amount of a deposit from a depositor;
identifier entering means in the remote input for entering identifiers that identifies a depositor, a depository agent, and the depository;
apportioning means responsive to said remote input and said identifier entering means for apportioning the deposit amount to one or more accounts on the basis of said identifiers;
entry/output means in the account manager to accept and aggregate the amounts in the accounts as a deposit from the depositor.
